(19) United States
(12) Patent Application Publication
(10) Pub. No.: US 2025/0362001 A1
(43) Pub. Date: Nov. 27, 2025

(54) HEADLAMP FOR VEHICLES AND CONTROL METHODS

(71) Applicant: HELLA GMBH & CO. KGAA, Lippstadt (DE)

(72) Inventors: Bernd Fischer, Altenbeken (DE); Daniela Karthaus, Büren (DE); Marc Kaup, Paderborn (DE); Boris Kubitza, Möhnesee-Körbecke (DE); Mathias Niedling, Erfurt (DE); Christian Schmidt, Paderborn (DE); Carsten Wilks, Lippstadt (DE); Dennis Zimmermann, Lippstadt (DE)

(21) Appl. No.: 19/216,083

(22) Filed: May 22, 2025

(30) Foreign Application Priority Data
May 23, 2024 (DE) 102024114380.0

(51) Int. Cl. F21S 41/663; F21S 41/143; F21V 23/00; F21W 102/17; F21Y 115/10

(52) U.S. Cl. CPC F21S 41/663; F21S 41/143; F21V 23/005; F21W 2102/17; F21Y 2115/10

(57) ABSTRACT

The invention relates to a headlamp for vehicles having a light source unit containing a plurality of light source elements for emitting light, an optical unit for mapping the light source elements to form a plurality of illumination areas from which a predetermined light distribution is composed, a control unit for generating a control signal by which the light source elements can be individually controlled depending on an ambient signal, an ambient sensor unit for generating the ambient signal by which ambient parameters in an area in front of the vehicle can be determined. The control unit is configured to generate a control signal dependent on the ambient signal, so that only those light source elements are controlled which are mapped in such a part of the light distribution in which there is a changed illuminance due to a light emitted by an external light source.

### CROSS-REFERENCE TO RELATED APPLICATIONS

The present application claims the benefit of German Patent Application No. 10-2024-114-380.0, filed May 23, 2024, the disclosure of which is incorporated by reference.

### FIELD OF THE INVENTION

The invention relates to a headlamp for vehicles with a light source unit containing a plurality of light source elements for emitting light, an optical unit for mapping the light source elements to a plurality of illumination areas which make up a predetermined light distribution, a control unit for generating a control signal by which the light source elements can be individually controlled as a function of an ambient signal, an ambient sensor unit for generating the ambient signal, by which ambient parameters can be determined in an area in front of the vehicle. Further, the invention relates to a method for controlling a headlamp for vehicles, wherein a plurality of light source elements are individually controlled as a function of ambient parameters and are mapped by an optical unit to form illumination areas of a predetermined light distribution.

### BACKGROUND OF THE INVENTION

DE 10 2020 122 322 A1 discloses a headlamp for vehicles that is designed as a high-resolution headlamp with a plurality of light source elements that form a light source unit. The light source elements are designed as LED lighting elements that are arranged on a common carrier or chip. Further, the headlamp comprises an optical unit with a lens device, by means of which the light source elements of the light source unit are each mapped to illumination areas of a predetermined light distribution. A control unit is provided for generating control signals by means of which the individual light source elements can be switched on or off or dimmed down. The control unit controls the light source elements in such a way that different partial light distributions are generated, depending on ambient parameters that are determined by an optical detection unit. In this way, partial light distributions can be generated if, for example, a pedestrian is detected on the right-hand side edge of the vehicle. If the vehicle is located in an urban area, a control signal can be generated automatically, by means of which the light source elements are controlled in such a way that a city light distribution is generated.

It is known from DE 10 2022 001 571 A1 to detect and evaluate street lighting in order to prevent a sudden change in lighting intensity when street lighting is obscured, for example by existing trees. However, the disadvantage of the known headlamp is that this lighting readjustment only becomes effective when the vehicle passes through the section of road again.

### SUMMARY OF THE INVENTION

The object of the present invention is to provide a headlamp for vehicles and a control method such that an optimum adjustment can be made relatively quickly depending on the ambient parameters.

To achieve this object, the invention includes a control unit that is configured to generate a control signal dependent on the ambient parameter such that only those light source elements are controlled which are mapped into such a part of the light distribution in which there is a changed illuminance due to light emitted by an external light source.

The particular advantage of the invention is that a predetermined light intensity distribution can be optimally adjusted depending on the ambient conditions, for example street lighting or road geometry. According to the invention, only some of the light source elements are controlled by dimming or switching off or switching on, which are mapped by an optical unit in illumination areas in which the illuminance changes due to an external light source. If, for example, an external light source, in particular street lighting that is switched on, is detected by a detection unit (camera), the part of the light source elements that is mapped in this part of the light distribution that is illuminated by the street lighting is dimmed down to a minimum light intensity or to a minimum luminous flux, so that a reduced illuminance is emitted in these illumination areas by the headlamp. The illuminance generated by the headlamp and the illuminance generated by the street lighting (street lamp) are superimposed to form the actual illuminance perceived by the driver of the vehicle, which is greater than a minimum illumination value and less than a maximum illumination value. Advantageously, in this way the light distribution in an illuminance band can be kept uniform or homogeneous, wherein the luminous intensity of light source elements can be dimmed down or switched off to save energy if sufficient external lighting is available.

According to a preferred embodiment of the invention, the light distribution is formed by a plurality of distance zones, with the distance zones differing from one another by illuminating different distance ranges. Each distance zone consists of a number of illumination areas, which are formed by a corresponding number of mapped light source elements. The size and/or dimension of the distance zones depends on expected and/or calculable ambient conditions or ambient influences. For example, a distance zone can correspond to a distance range in the area in front of the vehicle that corresponds to an illumination range of a street lamp. Advantageously, in this way, defined distance zones can be dimmed down, switched off, dimmed up or switched on.

According to a further development of the invention, at least one middle distance zone is provided which covers part of a lane of the vehicle. To the left and right of the middle distance zone, outer distance zones are arranged, which illuminate adjacent vehicle lanes or a side edge. Advantageously, only three different areas in the horizontal plane of the light distribution, which are defined by the distance zones, can be switched or controlled such that the desired illuminance distribution occurs in the horizontal plane. The control and regulation effort is therefore limited.

According to a further development of the invention, the light source elements of a right-hand headlamp of the vehicle and a left-hand headlamp of the vehicle can be controlled differently in such a way that a brightness gradient in a boundary space between adjacent distance zones is smaller than when the same light source elements of the left-hand and right-hand headlamps are controlled in the same way. Advantageously, an offset of the left-hand and right-hand headlamps in the horizontal direction can be used to achieve a smoother transition in terms of the illuminance distribution in the boundary area between two adjacent distance zones.

To achieve this object, the invention has the features of a method in accordance with another embodiment. The particular advantage of the method according to the invention is that when a predetermined upper threshold value is exceeded or a predetermined lower threshold value is undershot by the measured and/or calculated illuminance values in a part of the area in front of the vehicle, the light source elements are controlled with a corresponding control power for as long and to such an extent that the current illuminance in the corresponding part of the area in front of the vehicle is less than a predetermined upper threshold value and greater than a predetermined lower threshold value. The current illuminance or illuminance distribution in the part in front of the vehicle is made up of the illuminance of the headlamp and an external light source, such as light of street lamps. This has the advantage of allowing relatively quick adjustment to different lighting conditions in the area in front of the vehicle. In particular, the light from external light sources can be used advantageously to reduce the light output of the headlamp in order to save energy.

### BRIEF DESCRIPTION OF THE DRAWINGS

An embodiment of the invention is discussed in more detail below with reference to the drawings. In the figures:

FIG. 1 is a block diagram of a headlamp according to the invention;

FIG. 2 is a representation of a light distribution according to the invention consisting of a plurality of distance zones in the area in front of the vehicle;

FIG. 3 is an illuminance diagram in a distance zone illuminated by an external light source; and

FIG. 4 is a flow chart of the control.

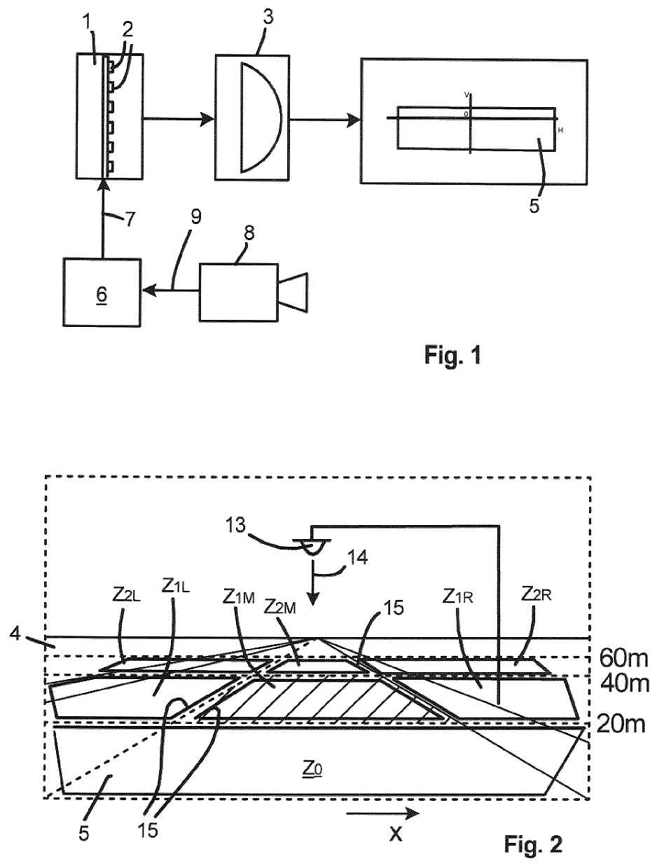

### DETAILED DESCRIPTION OF THE CURRENT EMBODIMENT

A headlamp for vehicles is arranged in a front area of a vehicle. It comprises a light source unit 1 with a plurality of light source elements 2 arranged in a matrix, which are preferably arranged on a common chip. The light source elements 2 are preferably designed as LED light sources.

Further, the headlamp comprises an optical unit 3, which has at least one lens for mapping the light source elements 2 in an area in front of the vehicle 4, wherein the light source elements 2 are each mapped to form illumination areas of a predetermined light distribution 5. For example, the light distribution 5 can be designed as a city light distribution, as shown in FIG. 2.

Further, the headlamp comprises a control unit 6, by which a control signal 7 is generated to control the light source unit 1 or the respective individually controllable light source elements 2. The light source elements 2 can be controlled in such a way that they are switched on or off or operated in a dimmed state, wherein the luminous intensity or luminous flux of the respective light source elements 2 can be set in a range between zero and a maximum value.

The light source unit 1, the optical unit 3 and the control unit 6 are arranged in a common housing. The control unit 6 is preferably arranged on the same printed circuit board as the light source unit 1. The optical unit 3 is arranged in front of the light source unit 1 in the main beam direction of the headlamp.

Further, the headlamp comprises an ambient sensor unit 8, preferably arranged remotely, which can be designed, for example, as a camera for capturing an image of the area in front of the vehicle 4. The ambient sensor unit 8 supplies the control unit 6 with image data 9, which is evaluated in the control unit 6 to determine the current illuminance in different areas of the areas in front of the vehicle 4.

As can be seen from FIG. 2, the light distribution 5 comprises different parts or distance zones Z₀, Z_{1M}, Z_{1R}, Z₂, Z_{2R}, Z_{2L}. A basic distance zone Z₀ extends across the entire horizontal width of the light distribution 5 in a range of a distance of 0 m to 20 m from the vehicle. A first distance zone, which is in a distance range between 20 m and 40 m from the vehicle, is formed by a first middle distance zone Z_{1M}, a first right distance zone Z_{1R} adjoining said distance zone on a right-hand side and a left first distance zone ZIL running on a left-hand side relative to the middle distance zone Z_{1M}. The first middle distance zone Z_{1M} extends along a lane 10 of the vehicle. The first right distance zone Z_{1R} extends to the right of the lane 10 in a side area 11. The first left distance zone Z_{1L} extends along a lane 12 of oncoming traffic, which is adjacent to the left-hand side of the first middle distance zone Z_{1M}.

In a further distance range between 40 m and 60 m away from the vehicle runs a second distance zone containing a second middle distance zone Z_{2M}, a second right distance zone Z_{2R} adjoining thereto on the right-hand side and a second left distance zone Z_{2L} running to the left of the middle distance zone Z_{2M}. Like the first middle distance zone Z_{1M}, the second middle distance zone Z_{2M} covers lane 10 of the vehicle. The second right distance zone Z_{2R} extends in the side area 11. The second left distance zone Z_{2L} runs in the area of lane 12 of oncoming traffic.

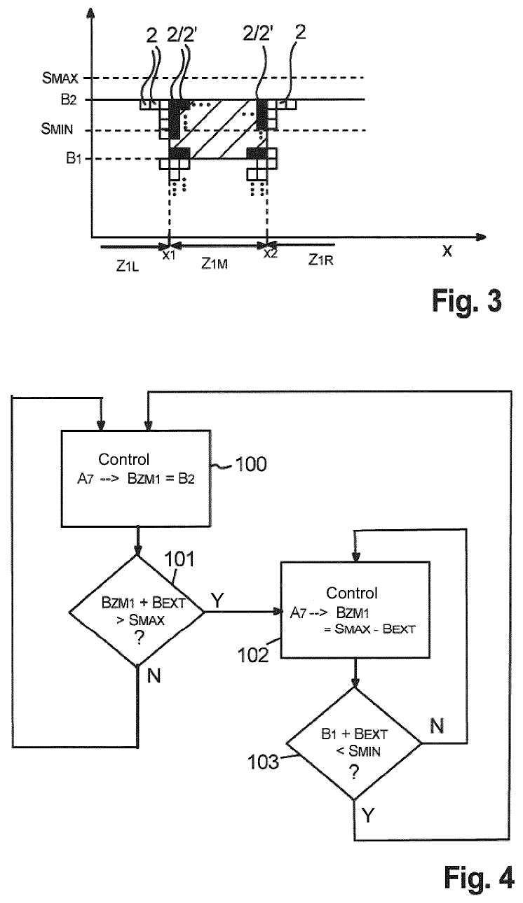

In an initial operating state of the city light distribution, the light source elements 2 are controlled in such a way that the specified light distribution 5 is generated, see step 100 in FIG. 4. The corresponding light source elements 2′ emit light such that the illuminance B₂ is present in the distance zone Z_{1M}.

If, during the journey, the ambient sensor unit 8 detects that an external light source 13, preferably a street lamp, is emitting light 14 onto the area in front of the vehicle 4, in the present embodiment onto the first middle distance zone Z_{1M}, which is indicated by hatching in FIG. 2, the control of the light source unit 1 is corrected. If the detection occurs at a first point in time, the illuminance in the first middle distance zone Z_{1M}, as a superposition of the luminous flux of the external light source 13 and the light source elements 2′ controlled for this distance zone Z_{1M}, would be above a maximum threshold value S_{MAX}. This comparison takes place continuously in an evaluation device of the control unit 6. If—as can be seen in step 101 according to FIG. 4—it is detected that the illuminance B_{ZM1} and the external illuminance B_{EXT} is greater than the maximum threshold value S_{MAX}, the control signal 7 is changed in such a way that the corresponding light source elements 2′ are dimmed down and controlled in such a way, that the sum of the current illuminance B_{ZM1} and the illuminance B_{EXT} of the external source corresponds to the illuminance B₂ that existed in the initial state of the light distribution 5 in the first middle distance zone Z_{1M}. The luminous flux emitted by the light source elements 2′ results in reduced illuminance B₁.

If the illuminance in the middle distance zone Z_{1M} decreases to such an extent that the sum of the illuminance B₁ of the headlamp and the illuminance B_{EXT} of the external light source 13 is less than a minimum threshold value S_{MIN}, the light source elements 2′ are dimmed up again to the initial state such that the light source elements 2′ are mapped to illumination areas with illuminance B₂, see steps 102, 103 and 100 in FIG. 4. This control according to step 100 remains valid until the maximum threshold value S_{MAX} is exceeded.

The control routine shown in FIG. 4 applies if the illuminance emitted by the headlamp in the respective distance zones exceeds the upper threshold value S_{MAX}. In the same way, if the value falls below the lower threshold value S_{MIN}, a reverse control can take place.

For the sake of simplicity, only two threshold values are specified in the present exemplary embodiment, namely the upper threshold value S_{MAX} and the lower threshold value S_{MIN}. In an alternative embodiment of the invention not shown, a plurality of threshold values can also be taken into account, so that a smoother transition with smaller differences in illuminance can take place at smaller time intervals. In the present exemplary embodiment, it is detected at the second point in time that the illuminance of the external light source 13 has been reduced to such an extent that the light source elements 2′ of the first middle distance zone Z_{1M} must be dimmed up again to the illuminance in the initial state 100 of the light distribution.

FIG. 3 shows the control state according to step 102. It can be seen that by superimposing a luminous flux from the external light source 13 and the headlamp, the same illuminance B₂ is present in the first middle distance zone Z_{1M} as at least in the edge areas of the adjoining adjacent right first distance zone Z_{1R} and left first distance zone Z_{1L}.

Preferably, the optical unit 3 is designed in such a way that the emerging boundary edges 15 of adjacent distance zones are softened, i.e. the illuminance at the boundary edges 15 of the adjacent distance zones does not drop abruptly, but decreases continuously. A brightness gradient of the corresponding distance zones Z_{1M}, Z_{1R}, Z_{1L}; Z_{2M}, Z_{2R}, Z_{2L} at the boundary edges 15 of said distance zones has a relatively low gradient.

According to an alternative embodiment of the invention, the horizontal offset of an identically designed right headlamp and left headlamp of the vehicle can be used to design brightness gradients at the boundary edges 15. The brightness gradient has a slight gradient at boundary edges 15 of the distance zones Z_{1M}, Z_{1R}, Z_{1L}; Z_{2M}, Z_{2R}, Z_{2L}.

Alternatively or additionally, according to a further embodiment of the invention, when the first middle distance zone Z_{1M} is relatively brightly illuminated by the external light source 13, the light source elements 2 can be controlled in such a way that the second middle distance zone Z_{2M} is illuminated with an increased illuminance compared to the initial state 100. This reduces the contrast between the middle first distance zone Z_{1M} and the second distance zone Z_{2M}, which makes the light distribution more homogeneous overall.

According to an alternative embodiment of the invention, the number of threshold values, i.e. the maximum threshold value S_{MAX} and the minimum threshold value S_{MIN}, can be increased in order to regulate the illuminance values in the respective distance zones to a predetermined output value B₂ or a target value. For example, a PID controller can be used to adjust the luminous intensity or luminous flux of the light source elements 2 such that the target illuminance is set in the corresponding distance zones in a relatively short time, i.e. dynamically.

### LIST OF REFERENCE NUMBERS

1 light source unit
2, 2′ light source elements
3 optics unit
4 area in front of the vehicle
light distribution
6 control unit
7 control signal
8 ambient sensor unit
9 image data
lane
11 lateral area
12 lane
13 external light source
14 light
boundary edges
Z . . . distance zones
B_{EXT}, B_{ZM1}, B₂, B₁ illuminance
S_{MAX} maximum threshold value
S_{MIN} minimum threshold value

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlamp for vehicles comprising:
a light source unit containing a plurality of light source elements for emitting light;
an optical unit for mapping the light source elements to form a plurality of illumination areas from which a predetermined light distribution is disposed;
a control unit for generating a control signal, such that the light source elements can be individually controlled depending on an ambient signal;
an ambient sensor unit for generating the ambient signal, such that ambient parameters in an area in front of the vehicle can be determined,
wherein the control unit is configured to generate a control signal dependent on the ambient parameter, so that only those light source elements are controlled which are mapped in such a part of the light distribution in which there is a changed illuminance due to light emitted by an external source.

2. The headlamp according to claim 1, wherein the part of the light distribution comprises a plurality of illumination areas of respectively mapped light source elements which can be controlled in such a way that the part of the light distribution is formed by superimposing the light emitted by the light source elements and the light emitted by the external light source, wherein resulting illumination values between a predetermined maximum threshold value and a predetermined minimum threshold value are set in this part of the light distribution.

3. The headlamp according to claim 1, wherein such light source elements are jointly controllable with the same control signal, the mapped illumination areas of which are located in a common distance zone of the light distribution, wherein the distance zones differ by a different distance from the vehicle, and in that at least two distance zones are provided which can each be switched on and off independently of one another or have dimmable illumination areas which are arranged next to one another in a horizontal direction.

4. The headlamp according to claim 1, wherein at least one distance zone is provided, which comprises a middle distance zone, a left distance zone which adjoins on a first side of the middle distance zone, and a right distance zone which adjoins on a second side of the middle distance zone arranged opposite the first side of the middle distance zone.

5. The headlamp according to claim 4, wherein the light distribution is designed as a city light distribution, wherein:
the middle distance zone illuminates one lane of the vehicle;
the left distance zone illuminates a further lane of a roadway or a side edge of the roadway;
the right distance zone illuminates a further lane of the roadway or a side edge of the roadway.

6. The headlamp according to claim 1, wherein the optical unit is configured such that a brightness gradient at boundary edges between two adjacent distance zones has such a low gradient that the illuminance curve of the adjacent distance zones overlap.

7. The headlamp according to claim 1, wherein the light source elements of a right headlamp and a left headlamp of the vehicle can be controlled differently in such a way that a curve of brightness gradients in an area of boundary edges between two adjacent distance zones has a smaller gradient than when the light source elements of the left and right headlamps are controlled in the same way.

8. The headlamp according to claim 1, wherein the light source elements are arranged on a chip in such a way that they are each mapped by via the optical unit to form illumination areas, such that the shape of the distance zones in the light distribution is set.

9. The headlamp according to claim 1, wherein the light source elements can be controlled in such a way that only at a minimum distance from the vehicle a plurality of distance zones arranged next to one another in the horizontal direction can be formed in different shapes and/or dimensions.

10. A method for controlling a headlamp for vehicles, wherein a plurality of light source elements are individually controlled depending on ambient parameters and are mapped via an optical unit to form illumination areas of a predetermined light distribution, wherein illuminance values of illumination areas of the light distribution generated in an area in front of the vehicle are determined, and in that, when a predetermined deviation of the determined illuminance values from predetermined illuminance values generated by mapping the respective light source elements is exceeded, the corresponding light source elements are dimmed such that the determined illuminance values lie within the predetermined deviation.

11. The method according to claim 10, wherein when a predetermined upper threshold value is exceeded as a deviation or when a lower threshold value is undershot as a deviation by the measured or calculated illuminance values of the light distribution in the area in front of the vehicle, the light source elements mapped in these illumination areas are controlled in such a way that the measured or calculated illuminance values are below the upper threshold value or above the lower threshold value.

12. The method according to claim 10, wherein the measured or calculated illuminance values are determined in groups for different distance zones.

13. The method according to claim 10, wherein the illuminance values in the area in front of the vehicle are determined by evaluating image data from a camera.

14. The method according to claim 10, wherein the illuminance values are calculated by detecting location data of external light sources, wherein the illuminance values result as a superposition of a light generated by the respective light source elements and a light emitted by the external light source.
